(19) United States
(12) Patent Application Publication
(10) Pub. No.: US 2023/0363423 A1
(43) Pub. Date: Nov. 16, 2023

(54) READY-TO-DRINK CARBONATED ELECTROLYTE BEVERAGE

(71) Applicant: ABBOTT LABORATORIES, Abbott Park, IL (US)

(72) Inventors: Gregory BRICKER, Powell, OH (US); Timothy LAPLANTE, Powell, OH (US); Kelley LOWE, Powell, OH (US); Normanella DEWILLE, Columbus, OH (US); Daniel ZEVCHIK, Blacklick, OH (US)

(21) Appl. No.: 18/246,380

(22) PCT Filed: Sep. 23, 2021
(86) PCT No.: PCT/US2021/051699

§ 371 Date: Mar. 23, 2023

Related U.S. Application Data
(60) Provisional application No. 63/083,543, filed on Sep. 25, 2020.

(51) Int. Cl. A23L 2/60; A23L 2/54; A23L 33/16; A23L 33/125; A23L 33/105

(52) U.S. Cl. CPC A23L 2/60; A23L 2/54; A23L 33/16; A23L 33/125; A23L 33/105

(57) ABSTRACT

A carbonated, oral rehydration beverage that includes about 25-75 mEq/L of sodium, about 15-40 mEq/L of potassium, about 20-55 mEq/L of chloride, dextrose, and at least about 2.0 volumes of CO₂. A method of treating or preventing dehydration is also provided.

### BACKGROUND

The present disclosure is related to carbonated, electrolyte beverages in a ready-to-drink form, methods of manufacturing such beverages, and methods of treating or preventing dehydration in an individual using such beverages.

Electrolyte beverages are typically used to provide hydration before, during, and after activities or events that deplete fluids and electrolytes in the body, including exercise, travel, exposure to heat, and sickness. Indeed, dehydration can be a significant health concern, particularly for those in poor or compromised health, including individuals experiencing one or more of fever, diarrhea, or vomiting. Oral rehydration beverages used to treat or prevent dehydration generally include a balance of electrolytes, especially sodium, chloride, and potassium, along with a carbohydrate (typically dextrose). These beverages not only provide much needed water, but also restore critical electrolytes needed for proper functioning of the body.

It is known that sodium ion absorption in the intestines causes water molecules associated with the sodium ions also to be absorbed. The addition of dextrose increases the uptake of sodium ions, and hence water, in the intestines. However, too much dextrose in a rehydration beverage can reduce water absorption. At higher concentrations, the dextrose can no longer be efficiently absorbed, leading to a net reduction in sodium and water absorption. In fact, higher concentrations of dextrose increase the osmotic load in the gut, which pulls water out of the blood stream. This leads to a net loss of fluids and electrolytes, further exacerbating dehydration.

The electrolyte ions in oral rehydration beverages, particularly when present at levels suitable for rehydration, provide a salty flavor that many find objectionable. Some beverages therefore contain lower electrolyte levels in order to reduce saltiness. Others attempt to mask the saltiness by adding more sweeteners, either in the form of various sugars (which add calories and reduce absorption) or artificial sweeteners that many consumers do not wish to ingest.

Many individuals prefer to drink carbonated beverages, as they enjoy the texture, mouthfeel, and flavor provided by carbonation. In addition, individuals suffering from gastrointestinal illness (nausea, vomiting, diarrhea), conditions that can result in dehydration, often drink clear, carbonated soft drinks (e.g., 7-Up®, Sprite®, ginger ale, etc.). These products are purported to alleviate the symptoms of gastrointestinal illness. However, the high sugar content of carbonated soft drinks can actually make dehydration worse. While some electrolyte beverages currently on the market may provide more effective rehydration than carbonated soft drinks, these are either non-carbonated (e.g., Pedialyte® electrolyte replacement beverage), or are only lightly carbonated (<2 volumes of CO₂) through an effervescent chemical reaction (e.g., Pedialyte Sparkling Rush® electrolyte replacement beverage).

Effervescent electrolyte beverages lack convenience in that they are not available in ready-to-drink (“RTD”) form. Instead, they must be prepared by the consumer prior to consumption by combining an effervescent powder or tablet with water. During this reconstitution step, an effervescent reaction occurs, generating carbon dioxide. However, due to the technical, nutritional, and organoleptic limitations related to effervescent reactions, these effervescent beverages provide significantly less carbonation than conventionally-carbonated soft drinks and other beverages (e.g., sparkling waters) that consumers enjoy.

While a variety of oral rehydration beverages may exist, it is believed that no one prior to the inventors has made or used an invention as described herein.

### SUMMARY

Embodiments of the present disclosure provide carbonated electrolyte beverages for use in rehydration (i.e., for preventing or treating dehydration). Some embodiments provide a carbonated, oral rehydration beverage having sodium, potassium and chloride at levels suitable for rehydration, and at least 2 volumes of CO₂.

Exemplary embodiments include an aqueous, carbonated, oral rehydration beverage comprising: about 25 to about 75 mEq/L of sodium; about 15 to about 40 mEq/L of potassium; about 20 to about 55 mEq/L of chloride; dextrose; and at least about 2.0 volumes of CO₂. In some instances the beverage further comprises a zinc source (e.g., to provide about 5 to about 15 mg/L of zinc). In still further instances, the beverage contains maltodextrin and/or corn syrup solids in place of, or in combination with, dextrose. The oral rehydration beverages described herein can optionally include one or more vitamins (e.g., vitamins B12, C, and/or E), minerals (e.g., magnesium), and other nutrients (e.g., fiber).

Other exemplary embodiments of the present disclosure include a carbonated, oral rehydration beverage comprising: about 30 to about 60 mEq/L of sodium; about 20 to about 40 mEq/L of potassium; about 30 to about 50 mEq/L of chloride; about 5 to about 15 mg/L of zinc; dextrose (e.g., about 6 to about 30 g/L of dextrose on an anhydrous basis; or about 30 mmol/L to about 170 mmol/L of dextrose); and about 2.0 to about 3.5 volumes of CO₂. In some instances, the beverage further comprises stevia extract and monk fruit extract, along with a small amount of sucrose (e.g., about 1 to about 6 g/L of sucrose).

Embodiments of the carbonated beverages of the present disclosure are ready-to-drink in that they are packaged in carbonated form (e.g., in cans, bottles, or other suitable containers). Carbon dioxide is dissolved in or injected into the beverage prior to or at the time of packaging such that the beverage requires no additional preparation by the consumer prior to consumption. Providing the carbonated electrolyte beverage in RTD form allows for higher levels of carbonation as compared to effervescent electrolyte beverages. In addition to providing higher levels of carbonation that many individuals desire, the inventors have surprisingly discovered that these carbonation levels unexpectedly provide a beverage that has a less salty flavor as compared to non-carbonated or lightly carbonated electrolyte beverages (<2 vol. of CO₂) having the same sodium concentration.

Other embodiments of the present disclosure comprise a concentrated beverage syrup that is mixed with carbonated water in order to produce a carbonated electrolyte beverage for use in rehydration or preventing dehydration. In these embodiments, the carbonated electrolyte beverage can be produced on demand by combining the beverage syrup with the appropriate amount of carbonated water (e.g., using a conventional carbonated beverage dispensing system) to provide the desired dilution and level of carbonation (at least about 2.0 volumes of CO₂).

Certain embodiments of the beverages of the present disclosure also include one or more sweeteners (in addition to dextrose, maltodextrin, and/or corn syrup solids). For example, stevia leaf extract and monk fruit extract are included in some beverages of the present disclosure. While stevia and monk fruit extracts are known to have a poor sweetness profile that many find unpleasant, the inventors have surprisingly found that a small amount of sucrose (e.g. about 1 to about 6 g/L) surprisingly improves the sweetness profile of the resulting beverage when used in combination with stevia and monk fruit. Thus, in some instances beverages of the present disclosure include sucrose in addition to stevia and monk fruit.

Embodiments of the present disclosure also include methods for preventing or treating dehydration (also known as oral rehydration therapy) in an individual by administering the carbonated oral rehydration beverages described herein.

### DETAILED DESCRIPTION

The following detailed description describes examples of embodiments of the invention solely for the purpose of enabling one of ordinary skill in the relevant art to make and use the invention. As such, the detailed description and illustration of these embodiments are purely illustrative in nature and are in no way intended to limit the scope of the invention, or its protection, in any manner.

The term “volumes” of CO₂, used herein to refer to the level of carbonation of the carbonated beverage, is a relative measurement of the volume of CO₂ that is dissolved in one volume of carbonated beverage. In this measurement, the “volume” of dissolved CO₂ is the volume that the dissolved gas (CO₂) would occupy at atmospheric pressure (1 atm) and 0° C. For example, 2 volumes of CO₂ correlates to 2 liters of CO₂ dissolved in one liter of the carbonated product.

A “milliequivalent” (mEq) refers to the number of electrolyte ions in a given volume of solution. One equivalent of an electrolyte (e.g., sodium) is the atomic mass of that electrolyte divided by its valence. The number of milliequivalents of a given electrolyte in a given volume is the weight of the electrolyte (in milligrams) multiplied by its valence and divided by its atomic mass. This measure is typically expressed as the number of milliequivalents per liter (mEq/L). Milliequivalents may be converted to milligrams by multiplying mEq by the atomic mass of the electrolyte and then dividing that number by the valence of the electrolyte.

The terms “administer,” “administering,” and “administration” as used herein, unless otherwise specified, should be understood to include providing the beverage to an individual, the act of consuming a composition by an individual, and combinations thereof.

The term “serving” as used herein, unless otherwise specified, refers to an amount that is intended to be consumed by an individual in one sitting or within one hour or less. For example, in some embodiments of the present disclosure a serving is 12 fluid ounces (355 mL).

Unless otherwise specified, any reference in the specification or claims to a quantity of an electrolyte or other ingredient should be construed as referring to the final concentration in the carbonated beverage.

The carbonated oral rehydration beverages of the present disclosure generally comprise water and the electrolytes sodium, potassium, and chloride in amounts suitable for rehydration (including for purposes of preventing or treating dehydration). The relative amounts of these electrolytes also help to maintain (or reestablish) proper electrolyte balance within the body. Electrolyte imbalances, particularly sodium, chloride, and potassium, can lead to life threatening situations, and these electrolytes can be lost through perspiration or as a result of diarrhea, vomiting, or other illness or medical condition. The beverages further include dextrose in order to provide rapid hydration, improve sodium absorption, and provide necessary calories. The beverages are carbonated to at least about 2.0 volumes of CO₂. Certain embodiments also include zinc, as zinc can be important for, among other things, supporting the immune system (e.g., in individuals dehydrated as a result of illness).

In some embodiments, the beverage is formulated to have about 25-75 mEq/L of sodium ions. In other embodiments, the beverage is formulated to have about 30-60 mEq/L of sodium ions, about 35-60 mEq/L of sodium ions, or about 40-50 mEq/L of sodium ions.

Sodium ions can be provided by a variety of sources, including one or more of: sodium chloride, sodium phosphate, sodium citrate, sodium carbonate, sodium bicarbonate, sodium hydroxide, and combinations thereof. In some embodiments, sodium ions are provided by a combination of sodium chloride and sodium citrate, which also provide chloride and citrate ions, respectively. Citrate (e.g., as sodium citrate and/or potassium citrate) also acts as a buffering agent, which helps maintain the desired pH of the beverage.

The oral rehydration beverages of the present disclosure further includes potassium. In some embodiments, the beverage is formulated to have about 15-40 mEq/L of potassium ions. In other embodiments, the beverage is formulated to have about 20-40 mEq/L of potassium ions, or about 20-30 mEq/L of potassium ions.

Potassium ions can be provided by a variety of sources, including one or more of: potassium chloride, potassium phosphate, potassium citrate, potassium carbonate, potassium bicarbonate, and potassium hydroxide. In some particular embodiments, potassium ions are provided by potassium citrate.

The oral rehydration beverages of the present disclosure also include chloride. In some embodiments, the beverage is formulated to have about 20-55 mEq/L of chloride ions. In other embodiments, the beverage is formulated to have about 30-50 mEq/L of chloride ions.

Chloride ions can be provided by a variety of sources, including one or more of: sodium chloride, potassium chloride, calcium chloride, and magnesium chloride. In some embodiments, chloride ions are provided by one or more of the same sources used to provide all or a portion of the sodium and potassium. Thus, in some particular embodiments, the chloride ions are provided by sodium chloride (which will also provide at least a portion of the sodium ions in the beverage).

As mentioned above, embodiments of the oral rehydration beverages of the present disclosure also include dextrose in order to improve sodium and water absorption, as well as to provide calories and sweetening. However, as mentioned previously, too much dextrose can slow the absorption of sodium and water or even exacerbate dehydration by pulling water out of the bloodstream. In addition, lower amounts of dextrose or other carbohydrates may provide nutritional benefits, as well as improved patient or consumer acceptance (in part, because dextrose increases the caloric and sugar content of the beverage). In certain embodiments, the oral rehydration beverages of the present disclosure include sufficient dextrose to provide a molar ratio of dextrose to sodium of between about 1:1 to about 3:1, between about 2:1 to about 3:1, or between about 2:1 and about 2.5:1.

On an absolute basis, embodiments of the oral rehydration beverages of the present disclosure include up to 225 mmol/L of dextrose. Other embodiments of the oral rehydration beverages of the present disclosure include between about 25 mmol/L and about 225 mmol/L of dextrose. Other embodiments of the oral rehydration beverages of the present disclosure include between about 30 mmol/L and about 170 mmol/L of dextrose, between about 35 mmol/L and about 150 mmol/L of dextrose, or between about 70 mmol/L and about 140 mmol/L of dextrose.

In some embodiments, maltodextrin and/or corn syrup solids can be substituted for all or a portion of the dextrose amounts specified herein. Maltodextrin and corn syrup solids are glucose polymers that are quickly broken down to glucose after ingestion. Maltodextrin having a dextrose equivalent of less than or equal to 20 and corn syrup solids having a dextrose equivalent of more than 20 are particularly useful to replace, individually or in combination, all or a portion of the dextrose specified herein. When maltodextrin and/or corn syrup solids are included (with or without dextrose) in the beverage, the amounts of dextrose, maltodextrin and/or corn syrup solids are such that a dextrose:sodium molar ratios mentioned previously (e.g., between about 1:1 to about 3:1) are maintained. In the case of maltodextrin and corn syrup solids, their molar contribution to the dextrose total in the beverage is based on their fully hydrolyzed form (i.e., conversion to glucose monomers). In other words, since maltodextrin and corn syrup solids are D-glucose polymers, their dextrose contribution is based on the number of glucose monomers in the polymer chain (which corresponds to the amount of dextrose resulting from the metabolism of the maltodextrin and corn syrup solids).

As discussed previously, the oral rehydration beverages of the present disclosure are carbonated. The level of carbonation is at least about 2.0 volumes, at least about 2.2 volumes, at least about 2.4 volumes, at least about 2.6 volumes, at least about 2.8 volumes, or at least about 3.0 volumes of CO₂. In some embodiments, the level of carbonation is about 2.0-3.5 volumes, about 2.2-3.5 volumes, or about 2.6-3.5 volumes of CO₂. The inventors have surprisingly found that these higher levels of carbonation (at least about 2.0 volumes) unexpectedly provide a beverage that has a less salty flavor as compared to non-carbonated or lightly carbonated electrolyte beverages (<2 vol. of CO₂) having the same electrolyte levels. This surprising benefit is significant in that the higher levels of carbonation are preferred by many consumers, particularly those suffering from gastrointestinal illness. The oral rehydration beverages of the present disclosure provide an alternative to clear, yet sugary, soft drinks that can actually exacerbate dehydration due to their high sugar content. By masking the saltiness present in conventional electrolyte beverages, those of the present disclosure provide more effective rehydration and electrolytes in a highly palatable beverage that provides a soda-like experience. This palatability and consumer acceptance, particularly for those suffering from gastrointestinal illness, is further enhanced when the beverages of the present disclosure are provided as clear liquids (which may or may not be lightly colored).

The beverages of the present disclosure can be carbonated in a variety of ways known to those skilled in the art or hereafter developed. For example, following the mixing of the ingredients with the appropriate amount of water, the resulting beverage solution is then carbonated and packaged. Suitable containers include, for example, metal (e.g., aluminum) cans and bottles, glass bottles, and plastic containers (e.g., plastic bottles). Conventional packaging equipment and systems can be used to package the carbonated beverage, and the beverage can be packaged in single-serving (e.g., 12 fluid ounces) or multi-serving containers.

By way of example, following mixing of the ingredients with the appropriate amount of water to form a beverage solution, the beverage solution is transferred to a carbonation tank. The tank is pressurized with CO₂ to achieve the desired level of carbonation, and the beverage solution then filled into containers. As is known to those skilled in the art, the amount of CO₂ that can be dissolved in a given quantity of liquid (i.e., CO₂ solubility) depends not only on the nature of that liquid, but also its temperature and the partial pressure of CO₂ in the gaseous atmosphere in contact with the liquid (i.e., Henry's Law). This relationship allows one to determine how much CO₂ can be maintained in solution in the beverage at a particular temperature and CO₂ saturation pressure. From the desired carbonation level for the beverage, the required saturation pressure (i.e., the CO₂ pressure above the liquid that is required to dissolve and maintain a specified amount of CO₂ in solution) at a given temperature can be determined (e.g., using predetermined data such as a solubility table or mathematical approximation). In some instances, the CO₂ pressure within the tank is elevated above the required saturation pressure needed to achieve the desired carbonation level in the final product in order to not only maintain the CO₂ in solution, but also to assist in the filling process.

As an alternative to using a pressurized carbonation tank, the beverages of the present disclosure can be carbonated by direct in-line CO₂ injection to achieve the target volumes of CO₂ described above, followed by packaging of the beverage in a conventional manner (e.g., single-serving cans or bottles).

As yet another alternative, a concentrated beverage syrup comprising the electrolytes, dextrose, other ingredients, and a portion of the water can be prepared. The beverage syrup can be concentrated between about 2 and about 10 times as compared to the single-strength carbonated beverage. In other embodiments, the beverage syrup is concentrated between about 3 and about 7 times as compared to the single-strength carbonated beverage. By way of example, when the beverage syrup is concentrated 5 times as compared to the final carbonated beverage, one part syrup and four parts carbonated water are used to prepare the single-strength carbonated beverage.

By way of example, the beverage syrup can be combined with carbonated water using a two-stream in-line mixing system to dilute the syrup and obtain a single-strength solution of the carbonated oral rehydration beverage having the desired volumes of CO₂ (e.g., 2.0-3.5 volumes). The carbonation level of the carbonated water combined with the syrup will be higher than that of the final beverage (since the carbonation level will be reduced by the volume of syrup). The carbonated, single-strength oral rehydration beverage is then filled and sealed into its primary container, such as aluminum cans, aluminum bottles, glass bottles, or plastic bottles. Finally, the filled containers are thermally processed at an elevated temperature for a period of time sufficient to achieve, at minimum, a 5-log reduction in microorganisms.

As a further alternative, a concentrated beverage syrup can be prepared and then combined with carbonated water on-demand, using a two-stream in-line mixing system such as those used to dispense carbonated soft drinks (also known as “fountain drinks”). In this instance, the syrup is packaged into bulk containers suitable for use with on-demand carbonated beverage dispensing systems, also known as post-mix beverage dispensing systems. Suitable syrup containers for such dispensing systems include bag-in-box containers, bags, pouches, bottles, and tanks. As a still further alternative, a measured amount of the packaged syrup can be added to a quantity of carbonated water, such as by simply pouring a small amount of the syrup into a single-serving container (e.g., a drinking cup or a water bottle).

Some embodiments of the oral rehydration beverages of the present disclosure include one or more sweeteners in order to improve the flavor profile of the beverage. The presence of one or more sweeteners is also beneficial in that the sweeteners allow for reduced amounts of dextrose and other sugars while maintaining an acceptable flavor profile. The sweeteners may be natural and/or artificial. Suitable artificial sweeteners include saccharin, nutrasweet, sucralose, aspartame, acesulfame-K (ace-K), and the like. When artificial sweeteners are used, the concentration of the artificial sweetener(s) can be from about 0.01 to about 0.5 grams per Liter (g/L).

Particular embodiments of the oral rehydration beverages of the present disclosure include one or more natural sweeteners, particularly high intensity natural sweeteners. Suitable high intensity natural sweeteners include stevia leaf extract (commonly referred to as “stevia”) and monk fruit extract (commonly referred to as “monk fruit”). Stevia and monk fruit are non-synthetic, high-intensity sweeteners that contribute no measurable amount of carbohydrates or calories and do not interfere with rehydration. Accordingly, the use of stevia and monk fruit allows the beverage to have sufficient sweetness for palatability without altering the ratio of dextrose to sodium for optimal sodium and water absorption.

In some embodiments, oral rehydration beverages of the present disclosure include between about 0.0037 and about 0.037 wt. % of stevia, monk fruit, or a combination of stevia and monk fruit. In embodiments that include both stevia and monk fruit, the amount of stevia is equal to or greater than the amount of monk fruit in the formulation. For example, the ratio of stevia to monk fruit (by weight) can be between about 1:1 and about 3:1, between about 1.5:1 and 2.5:1, or about 2:1. In some specific embodiments, Reb A 95% (a type of stevia extract) is used—alone or in combination with monk fruit extract.

While stevia and monk fruit are suitable high intensity natural sweeteners, they are known to have a poor sweetness profile, including bitterness and aftertastes that many find unpleasant. The inventors have surprisingly found that the addition of a small amount of sucrose surprisingly improves the sweetness profile of the resulting beverage when used in combination with stevia and/or monk fruit. Because only a small amount of sucrose is needed to provide the unexpected improvement in sweetness profile, the sucrose will not significantly increase the sugar or caloric content of the beverage. In fact, the sucrose can replace an equivalent amount of dextrose in the formulation, thereby maintaining the dextrose:sodium ratio in the desired range and not increasing the sugar or caloric content of the beverage. Thus, one embodiments of the beverages according to the present disclosure, particularly those that include stevia and/or monk fruit, also include between about 1 and about 6 g/L of sucrose. Other embodiments of the beverages according to the present disclosure include between about 3 and about 6 g/L of sucrose in combination with one or both of stevia and monk fruit.

In certain exemplary embodiments, the oral rehydration beverages of the present disclosure further comprise citrate. Citrate is useful in oral rehydration beverages for correcting acidosis associated with diarrhea and dehydration. The quantity of citrate varies widely. In certain exemplary embodiments, a source(s) of citrate is present in an amount sufficient to provide from about 10 to about 50 mEq/L, about 15 to about 45 mEq/L, or about 20 to about 40 mEq/L of citrate. Citrate ions can be provided by a variety of sources, including one or more of: citric acid, citric esters that can be hydrolyzed into citric acid or a citrate ion, and citrate salts such as potassium citrate and sodium citrate. In some embodiments, citrate ions are provided by one or more of the same sources used to provide all or a portion of the sodium and/or potassium. Thus, in some particular embodiments, the citrate ions are provided by sodium citrate (which will also provide at least a portion of the sodium ions in the beverage) and potassium citrate (which will also provide at least a portion of the potassium ions in the beverage).

Some embodiments of the oral rehydration beverages also contain a source of carbohydrate in addition to dextrose (and optionally sucrose). Any carbohydrate suitable for use in oral rehydration beverages can be present, including simple and/or complex carbohydrates, including monosaccharides, disaccharides, oligosaccharides, and polysaccharides. Specific examples of suitable carbohydrates include, but are not limited to, fructooligosaccharides, galacto-oligosaccharides, fructose and glucose polymers, corn syrup, high fructose corn syrup, maltodextrin, lactose, maltose, amylose, glycogen, galactose, allose, altrose, mannose, gulose, idose, talose, ribose, arabinose, lyxose, ribose, xylose, erythrose, threose, and combinations thereof. In some embodiments, the total level of carbohydrates (including dextrose and optionally sucrose) are between about 15 g/L and about 45 g/L so as to not hinder the absorption of sodium and water.

Beverages of the present disclosure can also include one or more additional ingredients, including those commonly used in electrolyte beverages that do not adversely affect the rehydration effects of the beverage. Examples of additional ingredients include flavorants, colorants, preservatives, excipients, indigestible oligosaccharides, amino acids, minerals (e.g., calcium), vitamins, dietary supplements, and combinations thereof.

Any of a variety of flavorants may be included to add or modify a flavor or to enhance the palatability of the beverage. Flavorants can be natural or artificial. Suitable natural flavorants include citrus oils such as lemon, orange, lime and grapefruit oils, and fruit essences, including apple, pear, peach, berry, wildberry, date, blueberry, kiwi, strawberry, raspberry, cherry, plum, pineapple, and apricot.

In certain exemplary embodiments, the oral rehydration beverages of the present disclosure are formulated as a clear or substantially translucent liquid (with or without colorant) having an acidic pH. In certain exemplary embodiments, the beverage has a pH greater than about 3.0, or greater than about 3.5. In still further embodiments, the pH of the beverage is between about 3.0 and about 5.0, or between about 3.5 and about 5.0. One or more acidulants can be included in the beverage in order to provide an acidic pH. In some embodiments, citric acid is included in the beverage for this purpose. Alternatively, one or more of phosphoric, malic, fumaric or tartaric acid are used in place of or in combination with citric acid, The beverages are substantially free of fat, containing less than 0.5% fat, or less than 0.1% fat by weight, in order to provide a clear or substantially translucent beverage. Certain exemplary embodiments of the oral rehydration beverages of the present disclosure also have an osmolality of about 300 mOsm/kg or less.

The carbonated oral rehydration beverages of the present disclosure are also formulated so as to exclude deleterious ingredients, particularly those that may interfere with rehydration or that are potentially harmful to some individuals. By way of example, the carbonated oral rehydration beverages of the present disclosure do not include quinine or its salts such as quinine hydrochloride or quinine hydrochloride dihydrate. While quinine purportedly can prevent leg cramps and restless leg syndrome, its side effects make it unsuitable for the oral rehydration beverages of the present disclosure. Similarly, in some embodiments the beverages include natural sweeteners (e.g., stevia and monk fruit), with no artificial sweeteners.

Table 1 below provides three exemplary electrolyte and nutrient profiles for certain oral rehydration beverages of the present disclosure.

TABLE 1
Exemplary Electrolyte/Nutrient Profiles

| | Target Range | | | | | |
|---|---|---|---|---|---|---|
| Electrolyte/Nutrient | A | | B | | C | |
| Sodium | 25-75 | mEq/L | 30-60 | mEq/L | 35-60 | mEq/L |
| Potassium | 15-40 | mEq/L | 20-40 | mEq/L | 20-30 | mEq/L |
| Chloride | 20-55 | mEq/L | 30-50 | mEq/L | 30-50 | mEq/L |
| Zinc | 5-15 | mg/L | 5-15 | mg/L | 5-15 | mg/L |
| Sugars | 15-30 | g/L | 15-30 | g/L | 15-30 | g/L |
| Citrate(s) | 10-50 | mEq/L | 15-45 | mEq/L | 20-40 | mEq/L |

One specific embodiment of an aqueous, packaged, carbonated, oral rehydration beverage of the present disclosure comprises or consists essentially of:
water;
dextrose;
citric acid;
potassium citrate;
sodium chloride;
sodium citrate;
at least one additional sweetener;
a source of zinc; and
carbon dioxide;
   wherein the beverage comprises about 30-60 mEq/L of sodium, about 20-40 mEq/L of potassium, about 30-50 mEq/L of chloride, and about 2.0-3.5 volumes of CO₂. In one particular embodiment, the additional sweetener in the above formulation can be stevia leaf extract in combination with monk fruit extract, in which case the beverage also comprises or consists essentially of sucrose. By way of further example, the source of zinc can be zinc gluconate, and the beverage can be packaged in single-serving containers (e.g., bottles or cans).

Another specific embodiment of an aqueous, packaged, carbonated, oral rehydration beverage of the present disclosure comprises or consists essentially of:
water;
dextrose;
30-60 mEq/L of sodium;
20-40 mEq/L of potassium;
30-50 mEq/L of chloride;
a source of zinc sufficient to provide 5-15 mg/L of zinc;
at least one additional sweetener;
about 2.0-3.5 volumes of CO₂; and
optionally, citrate.
   In one particular embodiment, the sweetener in the above formulation can be stevia leaf extract in combination with monk fruit extract, in which case the beverage also comprises or consists essentially of sucrose. By way of further example, the source of zinc can be zinc gluconate, and the beverage can be packaged in single-serving containers (e.g., bottles or cans).

The oral rehydration beverages of the present disclosure are prepared in a conventional manner. For example, the dry ingredients are combined with one another by dry blending, and the blend then dispersed in water (along with any other liquid ingredients) to obtain a beverage solution. The beverage solution is then transferred to a tank, pressurized and carbonated to the desired volumes of CO₂ (e.g., 2.0-3.5 volumes). Next, the carbonated oral rehydration beverage is filled and sealed into containers, such as aluminum cans, aluminum bottles, glass bottles, or plastic bottles. Finally, the filled containers are thermally processed at an elevated temperature for a period of time sufficient to achieve a suitable reduction in microorganisms (e.g., at least a 5-log reduction). By way of example, thermal processing may include tunnel pasteurization or retort. In one embodiment, the thermal processing is conducted at about 130-205° F., or at about 130-150° F. for about 20-60 minutes.

In the case of a beverage syrup, the dry ingredients are combined with one another by dry blending, and the blend then dispersed in the specified amount of water (along with any other liquid ingredients) to obtain the concentrated syrup. The beverage syrup is then combined with carbonated water. By way of example, the syrup can be combined with carbonated water using a two-stream in-line mixing system to dilute the syrup and obtain a single-strength solution of the carbonated oral rehydration beverage having the desired volumes of CO₂ (e.g., 2.0-3.5 volumes). The carbonated oral rehydration beverage is then filled and sealed into containers, such as aluminum cans, aluminum bottles, glass bottles, or plastic bottles. Finally, the filled containers are thermally processed at an elevated temperature for a period of time sufficient to achieve a suitable reduction in microorganisms (as described above).

Alternatively, a concentrated beverage syrup can be prepared as above, and the syrup then thermally processed at an elevated temperature for a period of time sufficient to achieve a suitable reduction in microorganisms. Thereafter, the syrup is packaged into sterilized bulk containers suitable for use with on-demand carbonated beverage dispensing systems, also known as post-mix beverage dispensing systems. Suitable syrup containers for such dispensing systems include bag-in-box containers, bags, pouches, bottles, and tanks.

The present disclosure also provides methods of treating or preventing dehydration in an individual using the carbonated, oral rehydration beverages disclosed herein. The method comprises providing a beverage having a composition as described herein, and orally administering the oral rehydration beverage to a dehydrated individual or an individual at risk of becoming dehydrated. An individual at risk of becoming dehydrated includes individuals about to engage in, or currently engaging in, an activity or event that depletes fluids and electrolytes in the body, including exercise, travel, or exposure to heat. An individual at risk of becoming dehydrated also includes individuals having an illness or medical condition that causes fever, diarrhea, vomiting, or other condition that tends to lead to dehydration if sufficient amounts of fluid and electrolytes are not administered.

### EXAMPLES

The following examples illustrate exemplary formulations of beverages according to certain embodiments of the present disclosure. These examples are given solely for the purpose of illustration and are not to be construed as limitations of the scope of the present disclosure or inventions described herein, as many variations are possible without departing from the spirit and scope of the present disclosure.

Table 2 is an exemplary formulation of a 1000 kg batch of an oral rehydration beverage before carbonation.

TABLE 2

| | | |
|---|---|---|
| Ingredient | Wt % | kg/1000 kg |

Dry Ingredients:

| | | |
|---|---|---|
| Dextrose Monohydrate | 2.17% | 21.7 |
| Sucrose | 0.540% | 5.40 |
| Citric Acid | 0.428% | 4.28 |
| Potassium Citrate Monohydrate | 0.230% | 2.30 |
| Sodium Chloride | 0.214% | 2.14 |
| Sodium Citrate Dihydrate | 0.113% | 1.13 |
| Stevia | 0.0151% | 0.151 |
| Monk Fruit | 0.00755% | 0.0755 |
| Flavor | 0.00750% | 0.0750 |
| Zinc Gluconate | 0.00637% | 0.0637 |
| Water | 96.3% | 963 |
| Total | 100.0% | 1000 |

The dry ingredients are combined with one another by dry blending, and the blend then dispersed in the specified amount of water to obtain a beverage solution. Alternatively, the dry ingredients can be directly dispersed in the specified amount of water. The beverage solution is then transferred to a tank, pressurized and carbonated to the desired volumes of CO₂ (e.g., 2.0-3.5 volumes). Next, the carbonated oral rehydration beverage is filled and sealed into its primary containers, such as aluminum cans, aluminum bottles, glass bottles, or plastic bottles. Finally, the filled containers are thermally processed at an elevated temperature for a period of time sufficient to achieve, at minimum, a 5-log reduction in microorganisms.

Table 3 is an exemplary formulation of a beverage syrup for use in preparing a 1000 kg batch of a carbonated oral rehydration beverage. Table 3 also indicates the amount of carbonated water combined with the syrup to prepare the carbonated oral rehydration beverage.

TABLE 3

| | | |
|---|---|---|
| Ingredient | Wt % | kg/1000 kg |

For Syrup:
Dry Ingredients:

| | | |
|---|---|---|
| Dextrose Monohydrate | 2.17% | 21.7 |
| Sucrose | 0.540% | 5.40 |
| Citric Acid | 0.428% | 4.28 |
| Potassium Citrate Monohydrate | 0.230% | 2.30 |
| Sodium Chloride | 0.214% | 2.14 |
| Sodium Citrate Dihydrate | 0.113% | 1.13 |
| Stevia | 0.0151% | 0.151 |
| Monk Fruit | 0.00755% | 0.0755 |
| Flavor | 0.00750% | 0.0750 |
| Zinc Gluconate | 0.00637% | 0.0637 |
| Water | 16.3% | 163 |
| Total- Syrup | 20.0% | 200 |

For Carbonation:

| | | |
|---|---|---|
| Carbonated Water | 80.0% | 800 |
| Total Carbonated Beverage | 100.0% | 1000 |

The dry ingredients are combined with one another by dry blending, and the blend then dispersed in the specified amount of water to obtain a concentrated beverage syrup. Alternatively, the dry ingredients can be directly dispersed in the specified amount of water. The beverage syrup is then combined with the specified amount of carbonated water. By way of example, the syrup can be combined with carbonated water using a two-stream in-line mixing system to dilute the syrup and obtain a single-strength solution of the carbonated oral rehydration beverage having the desired volumes of CO₂ (e.g., 2.0-3.5 volumes). The carbonation level of the carbonated water combined with the syrup is higher than that of the final beverage (since the carbonation level is reduced by the volume of syrup). The carbonated oral rehydration beverage is filled and sealed into its primary container, such as aluminum cans, aluminum bottles, glass bottles, or plastic bottles. Finally, the filled containers are thermally processed at an elevated temperature for a period of time sufficient to achieve, at minimum, a 5-log reduction in microorganisms.

Alternatively, the concentrated beverage syrup of Table 3 can be combined with the specified amount of carbonated water on-demand, using a two-stream in-line mixing system such as those used to dispense carbonated soft drinks (also known as “fountain drinks”). In this instance, after preparation of the concentrated syrup, the syrup is thermally processed at an elevated temperature for a period of time sufficient to achieve, at minimum, a 5-log reduction in microorganisms. Thereafter, the syrup is packaged into sterilized bulk containers suitable for use with on-demand carbonated beverage dispensing systems, also known as post-mix beverage dispensing system. Suitable syrup containers for such dispensing systems include bag-in-box containers, bags, pouches, bottles, and tanks. One or more preservatives can also be added to the syrup in order to extend the shelf life.

While various embodiments of carbonated, oral rehydration beverages have been described in detail above, it will be understood that the components, features and configurations, as well as the methods of manufacturing the devices and methods described herein are not limited to the specific embodiments described herein.

1. A carbonated, oral rehydration beverage comprising about 25-75 mEq/L of sodium, about 15-40 mEq/L of potassium, about 20-55 mEq/L of chloride, dextrose, sucrose, at least one of stevia leaf extract and monk fruit extract, and at least about 2.0 volumes of CO₂.

2. The oral rehydration beverage of claim 1, further comprising zinc, wherein the beverage comprises about 5-15 mg/L of zinc.

3. (canceled)

4. The oral rehydration beverage of claim 1, wherein the molar ratio of dextrose to sodium is between about 1:1 and about 3:1.

5. (canceled)

6. The oral rehydration beverage of claim 1, comprising stevia leaf extract and monk fruit extract.

7. (canceled)

8. The oral rehydration beverage of claim 1, wherein the beverage comprises about 1-6 g/L of sucrose.

9. (canceled)

10. The oral rehydration beverage of claim 1, wherein the beverage comprises at least one source of sodium chosen from the group consisting of: sodium chloride, sodium phosphate, sodium citrate, sodium carbonate, sodium bicarbonate, and sodium hydroxide.

11. The oral rehydration beverage of claim 1, wherein the beverage comprises at least one source of chloride chosen from the group consisting of: sodium chloride, potassium chloride, calcium chloride, and magnesium chloride.

12. The oral rehydration beverage of claim 1, wherein the beverage comprises at least one source of potassium chosen from the group consisting of: potassium chloride, potassium phosphate, potassium citrate, potassium carbonate, potassium bicarbonate, and potassium hydroxide.

13. The oral rehydration beverage of claim 1, wherein the beverage comprises a source of zinc chosen from the group consisting of: zinc gluconate, zinc sulfate, zinc chloride, zinc citrate, zinc bicarbonate, zinc carbonate, zinc hydroxide, zinc lactate, zinc acetate, zinc fluoride, zinc bromide, and zinc sulfonate.

14-15. (canceled)

16. The oral rehydration beverage of claim 1, wherein the beverage comprises about 2.0-3.5 volumes of CO₂ and is in packaged form.

17. The oral rehydration beverage of claim 1, wherein the pH of the of the beverage is between about 3.0 and about 5.0.

18. The oral rehydration beverage of claim 1, wherein the beverage comprises about 30-60 mEq/L of sodium.

19. The oral rehydration beverage of claim 1, wherein the beverage comprises about 20-40 mEq/L of potassium.

20. The oral rehydration beverage of claim 1, wherein the beverage comprises about 30-50 mEq/L of chloride.

21. The oral rehydration beverage of claim 1, wherein the beverage comprises about 25-225 mmol/L of dextrose.

22-24. (canceled)

25. The oral rehydration beverage of claim 1, wherein the combined amount of stevia leaf extract and monk fruit extract is between about 0.0037 and about 0.037 wt. %.

26. The oral rehydration beverage of claim 25, wherein the beverage comprises stevia leaf extract and monk fruit extract, and the ratio of stevia leaf extract to monk fruit extract is between about 1:1 and about 3:1.

27-29. (canceled)

30. An aqueous, carbonated, oral rehydration beverage comprising or consisting essentially of:
water;
dextrose;
sucrose;
citric acid;
potassium citrate;
sodium chloride;
sodium citrate;
at least one sweetener;
a source of zinc; and
carbon dioxide;
wherein the beverage comprises about 30-60 mEq/L of sodium, about 20-40 mEq/L of potassium, about 30-50 mEq/L of chloride, and about 2.0-3.5 volumes of CO₂.

31. The oral rehydration beverage of claim 30, wherein said at least one sweetener comprises or consists essentially of stevia leaf extract in combination with monk fruit extract.

32. (canceled)

33. A method for preventing or treating dehydration in an individual comprising the step of administering the oral rehydration beverage of claim 1 to a dehydrated individual or an individual at risk of becoming dehydrated.
